(19) United States
(12) Patent Application Publication
(10) Pub. No.: US 2010/0065015 A1
(43) Pub. Date: Mar. 18, 2010

(54) MECHANISM TO TRANSFORM A PISTON ALTERNATIVE MOVEMENT INTO AN AXLE REVOLVING MOVEMENT FOR INTERNAL COMBUSTION ENGINES

(75) Inventor: Angel Roberto BORGES, Rio Negro (UY)

Correspondence Address: LADAS & PARRY LLP, 26 WEST 61ST STREET, NEW YORK, NY, 10023, US

(73) Assignee: MAITENAR S.A.

(21) Appl. No.: 12/557,775

(22) Filed: Sep. 11, 2009

(30) Foreign Application Priority Data
Sep. 16, 2008 (UY) 31342

(51) Int. Cl. F02B 75/32

(52) U.S. Cl. 123/197.1

(57) ABSTRACT

The present invention refers to the transformation of piston alternative movement into an axle revolving movement. It increases the length of the lever and that applies the explosion strength to the axle without increasing the piston drive and therefore, the engine revolutions decrease considerably which implies a lower consumption. This technique then uses the piston—rod—bearing—sloped surface, eliminating the piston lateral efforts, obtaining a lower wear and tear and a better rings sealing with lower internal lubrication in the cylinder.

The creation whose patent is hereby requested consists basically of an efficient and simple mechanism for the construction of engines.

In accordance with the Strasbourg Agreement 1971, this invention technologic sector is F 02 B related to Pistons Internal Combustion Engines and Combustion Engines in General.

### TECHNICAL SCOPE OF THE INVENTION

It is an efficient and simple mechanism for engines construction either with internal combustion or compressed air, steam engines, hydraulic engines of different sizes, for vehicles (cars, motorbikes, launches), that is, in every locomotion field, as stationary drives for generators, water pumps, and wherever motive power is required.

### TECHNIQUE CONDITION

### Background

The mechanism used in conventional engines for one century which is piston-bolt-connection rod-crank, has been improved, studied and proved in millions of engines by thousands of technicians in the whole world, constituting the engine we have today with its advantages and defects.

The revolving Wankel engine of German origin also works but it does not surpass the conventional engine since it requires high precision and also exotic materials for its construction which places it on a disadvantageous position with regard to the conventional engine.

In our opinion, conventional engines had two fundamental defects which have not been solved.

1- We start by saying that the length of the lever of the crankshaft bearing can never be longer that 50% of the piston course and taking into account that by means of a connecting road the explosion strength is applied to that lever which is the one that makes the crankshaft rotate, the conventional engine mechanism cannot bear a lever bigger that that and we must remember what Physics has taught us: that the same product can be obtained with a little movement and great strength instead of great movement and little strength. Taking into account the strength which is produced by the explosion generated by the fuel burnt in the combustion chamber, it is clear to understand which of the two fuels will be more convenient to apply in order to make the most of the explosion strength. In the conventional engine mechanism a little course with a great strength is used. As a consequence, the conventional engine mechanism has to work at high revolutions to be able to develop strength. We must not forget that high revolutions generate within the engine inertial strength which tends to vibrate, break and brake the engine rotation which also produces fuel waste and consumption increases. The lever through which the explosion strength is applied to the crankshaft is minimal at the moment of maximum pressure of gases in the combustion chamber and reaches a value of 50% of the piston drive at 90° of the crankshaft rotation and the piston has driven 50% of its drive, therefore, the explosion has lost more that 50% of its strength. With that mechanism it is impossible to increase the piston drive.

2- The conventional engine piston stands strong lateral efforts during its drive in order to transmit the explosion strength to the connecting rod and the latter to the crankshaft lever in order to make it rotate which makes the piston, rings and cylinder suffer undesired frictions and therefore, temperatures, wear and consumption of energies inside the engine which do not come out through the engine axle complicating the sealing of rings and requiring abundant lubrication inside the cylinder. That functioning defect is also impossible to solve in a conventional engine since it works according to its design.

### Advances.

With the rotolinear mechanisms we are dealing with the most important inconveniences of conventional engines get solved in a very advantageous manner as well as other inconveniences it has to suffer in order to work which demand a long technical explanation.

This invention of the transformation of piston alternative movement into an axle revolving movement significantly increases the lever through which the explosion strength is applied to the engine axle and that lowers significantly the engine revolution keeping a high torque at low revolutions per minute (RPM) and therefore, a lower consumption.

Piston lateral efforts are also eliminated and as a consequence, rings are better sealed and a lower temperature in the piston with a minimal lubrication inside the cylinder is obtained.

We understand that at present we need more efficient engines which may (as in this invention) offer users a lower cost, lower fuel consumption, lower manufacturing and maintenance costs and also, a lower environmental contamination.

### Advantages

The above mentioned results are precisely obtained with this new transformations mechanism. This invention has the following advantages:
higher mechanic performance
higher thermodynamic performance using a chamber of double expansion
better use of movable pieces movements
lower number of auto-balanced movable pieces [without counterweight]
less internal frictions
application of strength to engine axle through two centered and simultaneous levers
size reduction of total pieces for the same power.

By using the above mentioned mechanism different varieties of engines can be manufactured which can work with oil derivatives as well as with compressed air engines, steam engines, hydraulic engines and liquids pumps. Due to that, the present invention offers society many advantages in the economic area because they simple engines, cheaper, with lower fuels consumption and lower maintenance costs and they also provoke less environmental damage.

Its design also allows the location of engines factories at places where today it is impossible to manufacture conventional engines or revolving Wankel engines. That means work opportunities for many people and higher quality lives for everyone.

This kind of engine can be used in internal combustion engines, also in compressed air engines, hydraulic engines, steam engines and liquids pumps, therefore, if applied to internal combustion engines, the starting, speed and turning off is similar to a conventional engine.

### Explanation

It is a kit of cams of complementary work in a preferably static position. The main cam has an internal command and with permanent work it is linked to a second cam of similar geometry but with external command in a parallel work position which we shall call “Expansion cam” that works when there is no pressure or strength between the heads of pistons located in a preferably revolving cylinder.

The main cam with internal command showed in FIG. 1 under N° 1, in its 360° of internal development, is formed by 4 stretches of sloped curves located in equal opposite pairs but each pair having different degrees being those degrees conveniently adjusted in accordance with the use the mechanism has thus forming an asymmetric geometry.

FIG. 1 shows stretch A1 (in blue color) which in this representation has a length of 80° but that may vary according to the application given to the mechanism.

When bearing 4 of FIG. 1 goes through the surface of the 80° stretch A1 of cam N° 1, corresponding piston 3 has an expansion drive and when going through that cam surface corresponding to stretch B3 (green color), FIG. 1, there is a compression drive in piston 3.

While these two drives take place at the piston we are dealing with, the same happens simultaneously when this piston is facing to the other piston. In this way the mechanism obtains the four drives per piston in the 360° revolving. By setting different degrees substantial improvements are obtained in the compression stage thus decreasing the braking of revolving produced, substantial improvements in bearing 4 surface support point on the sloping surface of cam 1 and improving significantly the bearing 4 movement which moves on the same.

By transforming the alternative piston movement into a revolving movement of central axle 6, the elimination of vibrations to the rotor body is obtained and also more or less revolutions per minute are obtained. Such disposition provides pistons faced under a dynamic perfect balance of masses under alternative movement without counterweights, tugs and smooth movements.

Under N° 7 FIG. 1 shows the point of the 2 pistons maximum expansion, under Lumber 8 it shows the two pistons at the point of maximum compression.

It is important to express that this mechanism is composed by only 2 pistons. FIG. 1 shows 4 for a better explanation of maximum and minimal points with regard to normal axles of circumferences.

Cam 2 of expansion and limitation towards the pistons interior works only when follower 5 at the right moment, allowed by the piston drive, lies support on cam 2 imposing radial movement at one moment and limitation towards the opposite pistons interior within cylinder 9, preferably revolving.

FIG. 2 shows, as cut of cam number 2, that it is complementary and parallel to cam number 1. With such a location of cam a high synchronization in this mechanism cinematic is obtained.

FIG. 2 shows cam number 2 located at work position with respect to cam 1 with follower 3 which goes through cam 2 at the right moment allowed by the piston drive.

In the technique we are dealing with piston-rod-bearing-sloped surface are used. By using them the piston lateral efforts are eliminated and therefore, there is less wear and tear and less temperature, better sealing of rings and lower internal lubrication of the cylinder.

In this mechanism it is possible to extend the lever length through which the explosion strength that makes axle 6 revolve is applied without increasing the piston drive.

The conventional technique uses the piston-bolt-crank. It is not possible to avoid the pistons lateral efforts because it is the support point on the cylinder in order to transmit to the crankshaft the strength that makes it revolve and transform the piston alternative movement into the crankshaft revolving movement carried out by means of the crank that cannot be higher that 50% than the piston drive.

Their main uses are in the industry where motive power is required in different levels of power and also compressed air propellers, steam propellers, hydraulic engines and liquids pumps.

### Explanation of Drawings

FIG. 1: it shows the form of internal command of cam 1. Its design is in accordance with its function demands in this mechanism which is to provide 4 drives to a piston under revolving 360° of a 4 cams follower that goes through it transmitting movement to piston 3. Those 4 drives are provided by the 4 curved stretches of the sloped surfaces which are duly located and graduated in cam number 1 internal 360° thus forming an asymmetric geometry. With the above mentioned curves disposition and with different degrees for each pair a high synchronization is obtained for each movement of this mechanism and it is also possible to vary bearing 4 support angle on cam 1 surface. Therefore, the internal command of cam 1 has no crests, no undulations or curves which are not due to the necessary synchronization of this mechanism movements, without vibrations, tugs or bumps.

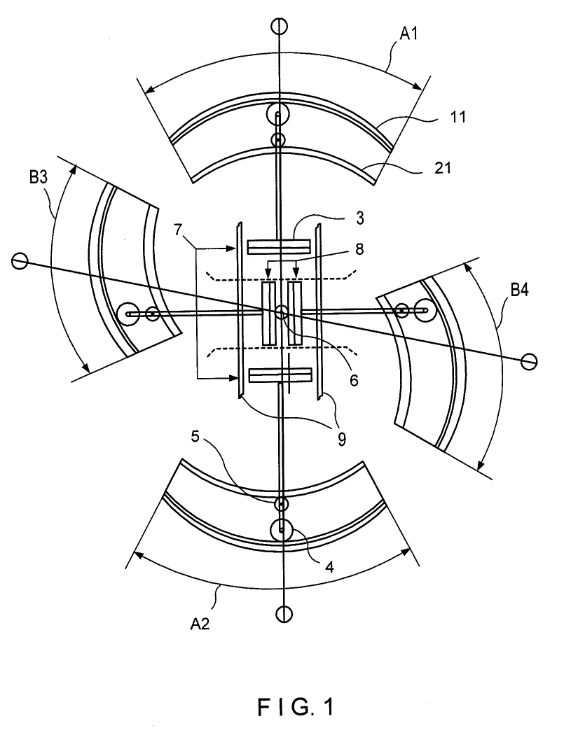

FIG. 2: it shows cam 2 cut of the external command which is for complementary and parallel work of cam 1 and shall be called expansion and limitation cam towards the inside of the unit piston-rod-bearing that works when there is no strength to expand among the piston heads. Cam 2 has the same geometry, at a lower degree, as cam 1 which shall adjust in accordance with cam 1. The follower is the means that at the right moment shall contact cam 2.

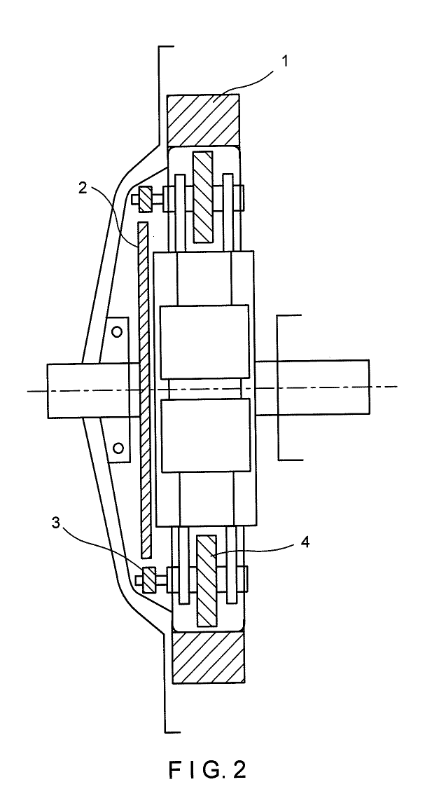

### Publications Related to Previous Techniques Conditions.

In the book “Explosion Motors” [“Motores a explosión”] by José F. Lucius—1, he explains the transformation of the piston alternative movement into the crankshaft revolving movement by means of the traditional mechanism piston-connecting rod-crank. He also mentions, as a consequence of the above, the piston lateral effort and the other inconveniences that the conventional engine has which have been very well known by technicians for a century.

### Forewords.

The present circumstances provoked by the rising prices of oil make us think that we need new propellers to save fuels which contaminate less since the very moment they are created, smaller and lighter, using the same materials. We think there must be a new mechanism which has lower manufacturing and maintenance costs which can be used by the user at a cost lower than the traditional maintenance costs.

1. A new mechanism for the transformation of a piston alternative movement into a revolving axle movement characterized by having a group of complementary cams in a preferably static position, the internal command main cam joins a second cam of identical symmetry but of internal command, in a parallel work position. With that cams disposition alternatives movements are provided to opposite pistons through their heads within a preferably revolving cylinder.

2. The previous claim was characterized by a new design of mechanism which transformed the alternative movement into a revolving axel movement. This claim, depending on the previous one, is characterized by a complementary work group of cams in a preferably static position being internal command main cam 1 characterized by being formed in its 360° by 4 curved stretches of sloped surfaces located in opposite pairs but with different degrees for each pair. Those degrees are conveniently adjusted according to the use the mechanism has, having a symmetric geometry applied to internal combustion engines, steam engines, hydraulic engines, compressors and liquids pumps.

3. Claim number 2 was characterized by the description of internal command cam number 1 which was characterized because it complements external command cam number 2 called “expansion and limitation cam”; the second claim is characterized by the fact that it works only in moments when there is no pressure to expand them between the pistons faces as well as in moments when the engine stops as a limit for the pistons drive towards the center.
